(19) United States
(12) Patent Application Publication
(10) Pub. No.: US 2025/0263027 A1
(43) Pub. Date: Aug. 21, 2025

(54) LAYERED TRIM STRUCTURE

(71) Applicant: BENTLEY MOTORS LIMITED, Crewe (GB)

(72) Inventors: Natasha WILLIAMS, Crewe (GB); Paul William THUNDERCLIFFE, Nantwich (GB)

(21) Appl. No.: 18/859,394

(22) PCT Filed: May 10, 2023
(86) PCT No.: PCT/GB2023/051227

§ 371 Date: Oct. 23, 2024

(30) Foreign Application Priority Data
May 10, 2022 (GB) 2206824.1

(51) Int. Cl. B60R 13/02; B60Q 3/54

(52) U.S. Cl. CPC B60R 13/02; B60Q 3/54; B60R 2013/0287

(57) ABSTRACT

A layered trim structure comprising an outer layer comprising a stitched pattern and at least one area configured to allow transmission of light, a resiliently compressible spacer layer configured to allow transmission of light and an at least partially opaque masking layer provided between the outer layer and spacer layer, the masking layer configured with at least one opening corresponding in position to the at least one area configured to allow transmission of light.

### TECHNICAL FIELD OF THE INVENTION

The present invention relates to improvements in or relating to illuminated fabrics. Particularly, but not exclusively, the present invention relates to an illuminated fabric for use in the trim and upholstery of vehicles.

### BACKGROUND TO THE INVENTION

It is known for vehicles to comprise trim arrangements which comprise layered materials. Conventionally, the materials comprise a decorative outer layer, which covers an inner layer made from a spacer material. The outer layer is aesthetically appealing (to touch and/or visually), and is typically made from leather, fabric or cloth (whether natural or synthetic). Conventionally, the spacer material is resiliently compressible, so as to provide a soft touch, and is usually provided in the form of a foam or a fabric.

In luxury vehicles, the trim arrangements often comprise a decorative pattern on their outer surfaces, created with methods which may include stitching and/or perforations. Whilst being decorative, any such stitching conventionally also serves to attach the outer later and spacer material to one another.

It is also known, particularly in luxury cars, to provide a 3D surface using the layered material, for example quilted leather. This is achieved by stitching the outer layer (in this case leather) and spacer material together in a quilted pattern, which compresses the spacer material in the vicinity of the stitches, to provide a 3D quilted effect, as the spacer fabric is less compressed in the regions further away from stitches.

Typically, once the layered material has been formed, the spacer material is directly attached to a rigid supporting substrate using an adhesive, which enables the trim and/or upholstered part to be fastened to the vehicle as required. This also serves to emphasize the 3D texture of the material, as the rigidity of the supporting surface ensures the spacer fabric pushes against the outer layer.

It is also known to provide vehicle trim parts which are illuminated. In such cases, the spacer material is (at least partially) translucent and/or transparent, allowing the spacer material to transmit light. In such trim parts, when a light source is provided, the spacer material is able to transmit light through the outer layer (and, where perforations are present, through any perforations therein).

One issue associated with such illuminated trim parts is that decorative stitching and/or any stitching which attaches the outer layer to the spacer material, also allows light to be transmitted through the outer layer. In some, but not all cases, this may provide an unwanted aesthetic appearance.

It is an object of the present invention to provide a layered material which, at least partially, overcomes and/or ameliorates these issues.

### SUMMARY OF THE INVENTION

According to a first aspect of the present invention, there is provided a layered trim structure comprising an outer layer comprising a stitched pattern and at least one area configured to allow transmission of light, a resiliently compressible spacer layer configured to allow transmission of light and an at least partially opaque masking layer provided between the outer layer and spacer layer, the masking layer configured with at least one opening corresponding in position to the at least one area configured to allow transmission of light.

Preferably, the at least partially opaque masking layer will effectively prevent light from passing except where an opening is formed through the at least partially opaque masking layer. In particular, the at least partially opaque masking layer may include at least one masking portion corresponding to at least the stitched pattern of the outer layer.

Providing a layered trim structure with the at least partially opaque masking layer as described above allows passage of light through the spacer layer and through the at least one area configured to allow transmission of light of the outer layer so as to be visible, but which prevents light which passes through the spacer layer, from passing through the masked portions, particularly the stitching in the outer layer. This may function to ensure that the layered trim structure includes a stitching pattern on the outer layer but only allows light to pass where the at least partially opaque masking layer has at least one opening, which is in turn aligned with the at least one area configured to allow transmission of light.

According to a second aspect of the present invention, there is provided a method of manufacturing a layered trim structure, the method comprising the steps of:
providing a stitching pattern and at least one area configured to allow transmission of light in an outer layer;
positioning an at least partially opaque masking layer comprising at least one opening relative to the outer layer such that the at least one opening in the masking layer corresponds in position to the at least one area configured to allow transmission of light in the outer layer, and
placing a resiliently compressible spacer layer configured to allow transmission of light onto at least partially opaque masking layer to sandwich the at least partially opaque masking layer to the outer layer.

As with the apparatus, the at least partially opaque masking layer will effectively prevent light from passing except where an opening is formed through the at least partially opaque masking layer. In particular, the at least partially opaque masking layer may include at least one masking portion corresponding to at least the stitched pattern of the outer layer.

The method preferably includes the step of laminating the outer layer, the masking layer and the spacer layer together in a lamination step.

The method preferably includes a further step of deforming the spacer layer to decreased thickness corresponding to the stitching pattern in an embossing step. The deformed, decreased thickness spacer layer may be formed by compression of the spacer layer corresponding to the stitching pattern. Preferably, any deformation of the spacer layer corresponding to the stitching pattern will be permanent.

This can be achieved in a number of ways for example utilising a welding machine. A welding machine may be used at a suitable temperature and/or pressure to compress the spacer layer. A heated press may be used at a suitable temperature and/or pressure to compress the spacer layer. A hand operated roller may be used at a temperature and/or pressure to compress the spacer layer.

The spacer layer may be formed or deformed prior to attachment of the masking layer and/or outer layer. For example, the spacer layer may be moulded before being attached to the masking layer and/or outer layer and be attached, in a pre-moulded or already moulded form.

The spacer layer may be attached to the masking layer which is attached to the outer layer at the same time. Alternatively, the masking layer may be attached to the outer layer and then the spacer layer may be attached to the masking layer. Alternatively, the spacer layer may be attached to the masking layer and then attached to the outer layer.

The deformation of the spacer layer may be achieved at the same time or as a consequence of attaching the respective layers together.

The further step of pressing the respective layers together using a heated press having at least one raised part corresponding to the stitching pattern in the outer layer to hold the layered trim structure together, and to plastically deform the spacer layer corresponding to the stitching pattern.

The lamination step and embossing step may occur at the same time, using the same apparatus. The lamination step may occur without an embossing step. The lamination step may occur before the embossing step or after the embossing step.

The at least one area configured to allow transmission of light may include at least one perforation through an opaque outer layer. However, the outer layer may be or comprise a fabric which may allow transmission of light therethrough.

More than one perforation may be provided in at least one perforated area. Each perforation may be aligned with a respective opening in the masking layer. This may provide a brighter more resolved lighting effect given that an area surrounding each perforation is masked but may be difficult to obtain a sufficiently precise alignment. This could be achieved by forming the stitching pattern in the outer layer, then attaching or applying the masking layer to the outer layer and perforating through both layers at the same time.

Alternatively, an opening may be aligned with each at least one perforated area. This may make alignment simpler given the larger areas involved and light bleed from one perforation through one or more adjacent perforations is less of a problem.

According to a third aspect of the present invention there is provided, an illuminated vehicle trim comprising an outer layer comprising a stitched pattern and at least one area configured to allow transmission of light, a resiliently compressible spacer layer, an at least partially opaque masking layer provided between the outer layer and spacer layer, the masking layer configured with at least one opening corresponding in position to the at least one area configured to allow transmission of light and a light source, the outer layer and the spacer layer each having an outer surface and an inner surface, the outer surface of the spacer layer facing the inner surface of the outer layer, and wherein the spacer layer is made of a material that allows light to pass through it and the light source is operable in use to direct light through the spacer layer to the outer cover to be visible through the at least one area configured to allow transmission of light.

The outer layer may be a flexible material which may be manmade or natural. The outer layer may be a leather, fabric or cloth material. The outer layer may be made from an opaque material, in which case the outer layer may be perforated to allow for the transmission of light. Where the outer layer is leather, it may be skived and/or it may be bi-cast natural leather.

The outer layer may have any thickness between 0.1 mm and 6.0 mm but will preferably be between 0.5 mm and 3 mm in thickness and more preferably, between 0.6 mm and 1.2 mm in thickness.

The outer layer will preferably be cut to a required shape for the trim structure. The outer layer will preferably be perforated. The cutting to shape and the perforation may be achieved in the same step or in different steps. In one form, a die cutting press may be used, however, other suitable methods include a laser or CNC cutting. This allows control and reproducibility of the shape of the outer layer once cut and/or the location of the perforations in the outer layer.

The outer layer may be provided with one or more extensions or tabs extending outwardly from an outer edge thereof. Each of the one or more extensions or tabs may be provided with an opening or aperture therethrough. The one or more extensions or tabs with an opening or aperture may be used to locate the outer layer on a laminating press, to locate the outer layer during stitching and/or in an embossing press. The one or more extensions or tab may also assist with locating and retaining the trim structure during trimming to the substrate. Preferably, the outer layer is positioned with the ‘A’ surface down and the ‘B’ surface facing upwardly. The masking layer may be located directly onto the ‘B’ surface of the outer layer, in the press.

At least one perforation may be formed through the outer layer. Preferably, a plurality of perforations is provided. Any number of perforations may be provided. The perforations can be provided in any pattern or shape. The perforations may be provided in one or more clusters, areas or arrays. Where provided in one or more clusters, areas or arrays, a boundary portion, without perforations may be provided, preferably around each cluster, area or array.

Stitching provided in the outer layer may be embroidered into the outer layer. In one form, a CNC embroidery machine could be used. Again, this provides control and reproducibility in the form and position of the stitching on the outer layer. The stitching is preferably into the outer layer only. This contrasts with prior art methods in which stitching is applied through the outer layer and substrate (spacer layer) to create a quilted effect.

The stitching may have any configuration. The stitching may be provided through a boundary portion around one or more clusters, areas or arrays.

An at least partially opaque masking layer is preferably provided between the outer layer and spacer layer, the masking layer configured with at least one opening corresponding in position to the at least one perforation.

The masking layer may have any thickness between 0.02 mm and 5.0 mm. In a more preferred form, the masking layer may be within a range of 0.02-2 mm, but will preferably be approximately 0.5 mm in thickness.

The masking layer may preferably be cut into shape to correspond with the configuration of stitching and at least one area configured to allow transmission of light into the outer layer. The masking layer may be cut to shape using a die cut press.

The masking layer will preferably have at least one opening corresponding in position to the at least one area configured to allow transmission of light. As mentioned above, an opening may be provided for each perforation. In this case, precision will be needed between the position of the openings in the masking layer and the position of the perforations in the outer layer. The same machine may be used to form the perforations in the outer layer and the openings in the masking layer.

Alternatively, as discussed above, an opening may be formed into the masking layer which is sufficiently large to correspond to at least one area configured to allow transmission of light including at least one area of perforations provided in one or more clusters, areas or arrays. As discussed above, where perforations are provided in one or more clusters, areas or arrays, a boundary portion without perforations may be provided around each cluster, area or array in the outer layer.

A masking portion may be provided in the masking layer corresponding to a boundary portion(s). A masking portion may be provided in the masking layer preferably provided corresponding to the stitching in the outer layer. In this configuration, the masking layer will preferably therefore be provided as a layer with a series of openings and a series of connecting, masking portions corresponding to the boundary portions in the outer layer (through which the stitching is preferably provided).

One preferred material for the masking layer is T5000 material available from West Bridgford Machines.

Although the masking layer is preferably provided cut to shape and configuration to correspond to the configuration of the outer layer, the masking layer may be formed using a plurality of smaller masking layer parts to form the masking layer. Use of smaller masking layer parts could be used for smaller trim structures or outer layers with smaller boundary portions between perforated clusters, areas or arrays.

The masking layer may be provided relative to the stitching pattern only.

The masking layer will preferably have continuous cover on the outer layer, except in locations corresponding to the at least one perforation. Providing a unitary masking layer with continuous cover except where light transmission is intended may make the masking layer easier to position and apply.

The masking layer may be cut to shape to correspond to the outer layer with one or more extensions or tabs extending outwardly from an outer edge thereof. Each of the one or more extensions or tabs may be provided with an opening or aperture therethrough. The one or more extensions or tabs with an opening or aperture may be used to locate the masking layer on a press, relative to the outer layer.

Use of the extensions or tabs on the masking layer may assist with alignment of the masking layer correctly with the outer layer.

The masking layer will preferably be attached directly to the outer layer. The masking layer may be directly attached to the ‘B’ surface of the outer layer. Whilst any method may be used, an adhesive may be preferred. A heat activated adhesive may be particularly preferred. The adhesive may be provided to the outer layer, and/or the masking layer.

The resiliently compressible spacer layer may be made of a material which in use diffuses the light as it passes through it. In this embodiment, the spacer layer is operable in use to scatter light from the light source so that it is incident over a broad area of the inner surface of outer cover.

The spacer layer may have any thickness between 1.0 mm and 12.0 mm but will preferably be between 3.0 mm and 6.0 mm in thickness.

The spacer layer may be cut to shape to correspond to the shape required for the trim structure.

The spacer layer may be a fabric or a foam. The outer surface of the spacer layer may be bonded to the inner surface of the at least partially opaque masking layer. Whilst any method may be used, an adhesive may be preferred. A heat activated adhesive may be particularly preferred. The adhesive may be provided to the masking layer, and/or the spacer layer.

The spacer layer may be deformed to decreased thickness corresponding to the stitching pattern. The deformed, decreased thickness spacer layer may be formed by compression of the spacer layer corresponding to the stitching pattern. Preferably, any deformation of the spacer layer corresponding to the stitching pattern will be permanent.

This can be achieved in a number of ways for example utilising a press. A press may be used at a suitable temperature and/or pressure to compress the spacer layer. A heated press may be used at a suitable temperature and/or pressure to compress the spacer layer. A hand operated roller may be used at a temperature and/or pressure to compress the spacer layer.

The press may have an upper (heated) tool with a raised pattern which, in this case, corresponds to the configuration of the outer layer. Preferably, the raised pattern corresponds to the configuration of the stitching pattern on the outer layer. The bottom tool of the press may be a planar plate. One or more upstands may be provided relative to the bottom tool in the press and over which the openings in the one or more extensions or tabs on the outer layer and the masking layer are located to align the outer layer and masking layer.

In an embodiment, once the outer layer, masking layer and spacer layer are positioned in the press, the press is closed in an embossing step, causing the three layers to become adhered together and the spacer layer to be plastically deformed by the raised regions of the top tool in the press. Accordingly, the spacer layer becomes compressed along the lines of stitching as if the spacer layer were quilted (attached to the outer layer by the stitching), but without stitching passing through the spacer layer (or masking layer). At this stage the A surface of the outer layer may still appear flat and the texture will be on the back (B-surface) of the now-connected three layer trim structure.

The spacer layer may be deformed prior to attachment to the masking layer and/or outer layer.

The deformation of the spacer layer may be achieved at the same time or as a consequence of attaching the respective layers together.

The embossing step may take place at a temperature between 0° and 300°.

The embossing step may last for between 10 to 120 seconds.

The embossing step may take place at a pressure between 0 Bar and 10 Bar.

The trim structure assembly may be attached/adhered to an illuminated/illuminatable substrate. Although any method could be used, a spray adhesive may be preferred.

A vacuum process (similar to vacuum forming) may be used to attach the trim structure assembly and illuminated/illuminatable substrate. In an embodiment, a cover layer is placed over the A surface of the trim structure assembly and the illuminated/illuminatable substrate located adjacent to the inner surface of the spacer layer (with an adhesive between). The trim structure assembly may then be pressed into contact with the adhesive and the illuminated/illuminatable substrate. This can be performed by hand and/or using a tool. Particular pressure may be applied to the stitching pattern to ensure adhesion in those areas. A vacuum may then be applied to hold the trim structure assembly into close contact with the illuminated/illuminatable substrate while the adhesive cures. Heat or other mechanisms may be used to trigger adhesion or to cure more quickly or effectively. This holds the inner surface of the spacer layer (which is deformed) into contact with the illuminated/illuminatable substrate with the effect that the “quilted” texture becomes apparent on the A surface. The already deformed parts of the trim structure are then ‘lower’ on the A surface and the remainder will be raised on the A surface due to the thickness of the undeformed spacer layer, to create the quilted effect. Other methods, for example applying pressure by hand or with a tool may be preferred.

The illuminated/illuminatable substrate may be or include a light source. The light source may comprise a light plate having an inner major surface and an outer major surface directed towards the inner surface of the spacer layer. The light source may comprise a light guide positioned adjacent an edge of the light plate, the light guide being operable in use to direct light transmitted along it into the light plate. The inner major surface of the guide plate may be provided with a light reflective layer for directing light incident on it internally of the plate towards the outer major surface of the guide plate.

The light source may comprise at least one light emitting member. The light emitting member may be selected from the group consisting of: a bulb, an LED and a laser. The light emitting member may be configured in use to emit white light or light in one or more colours. The light emitting member may be a white LED or an RGB LED. Where the light source comprises a light plate, then at least one light emitting member may be arranged in use to direct light directly into the light plate.

Alternatively, where the light source comprises a light guide positioned adjacent an edge of a light plate, the light emitting member and the light guide may be configured such that, in use, light emitted from the light emitting member enters and is transmitted along the light guide.

Alternatively, the light emitting member may be a light emitting film configured in use to emit light into the spacer layer. The light emitting film may be laminated to an inner surface of the spacer layer and/or may be an OLED.

Where the light source comprises a light guide, the trim may be provided as a laminated trim panel with the spacer layer laminated directly or indirectly to the outer major face of the light guide plate. In this embodiment, the light plate may function as a supporting substrate for the trim panel with no additional supporting substrate provided. Alternatively, the light plate may be secured to a supporting substrate, which may be a part of the vehicle structure such as a door substrate, body panel, dashboard or console.

Where the light emitting member is a light emitting film, the light emitting member may be attached to a supporting substrate on the side opposite from the spacer layer.

According to a fourth aspect of the present invention, there is provided a method of manufacturing a layered trim structure, the method comprising the steps of:
providing a stitching pattern and at least one area configured to allow transmission of light in an outer layer;
placing a resiliently compressible spacer layer configured to allow transmission of light onto at least partially opaque masking layer to sandwich the at least partially opaque masking layer to the outer layer; and deforming the spacer layer to decreased thickness corresponding to the stitching pattern.

The deformed, decreased thickness spacer layer may be formed by compression of the spacer layer corresponding to the stitching pattern. Preferably, any deformation of the spacer layer corresponding to the stitching pattern will be permanent.

### DETAILED DESCRIPTION OF THE INVENTION

In order that the invention may be more clearly understood one or more embodiments thereof will now be described, by way of example only, with reference to the accompanying drawings, of which:

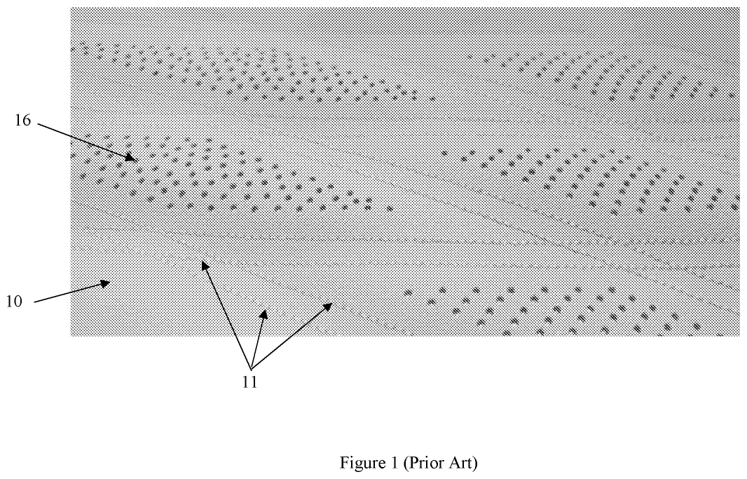

FIG. 1 is an axonometric view of a prior art perforated, quilted trim structure for a vehicle panel with stitching.

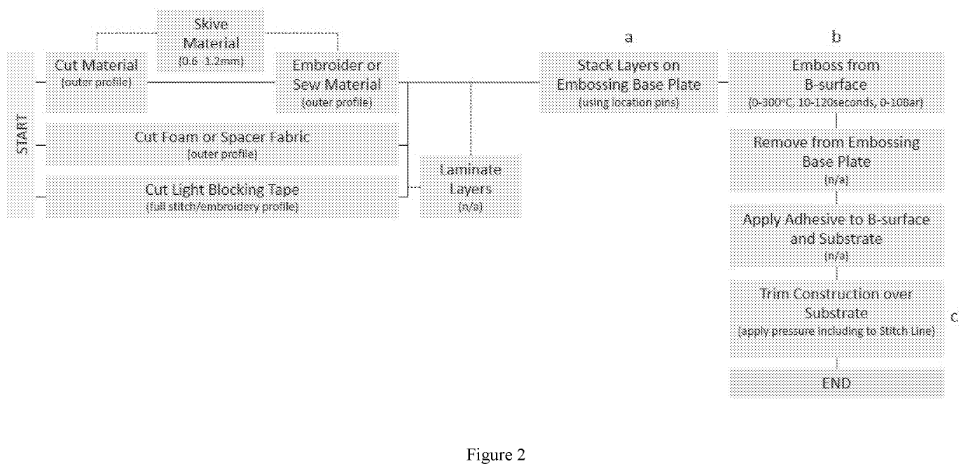

FIG. 2 is a flow diagram of a method of an embodiment of the invention.

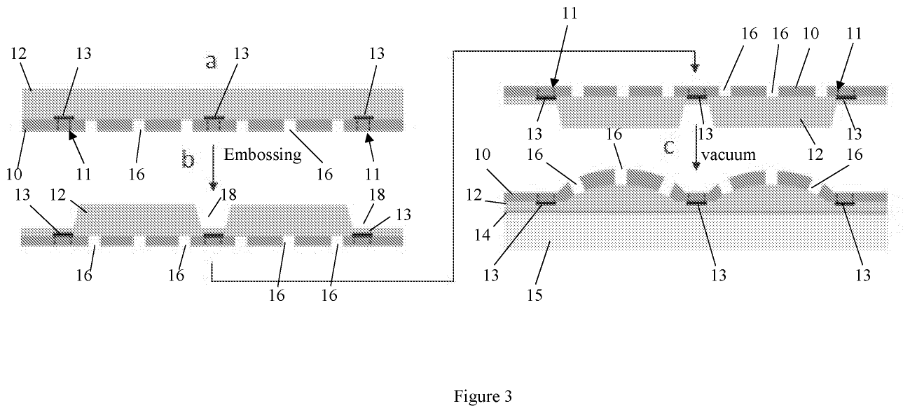

FIG. 3 is a schematic view of the trim structure of an embodiment at points in the method of an embodiment.

FIG. 4 is a schematic side section view of a trim structure of an embodiment in which an opening is provided in the masking layer for each perforation.

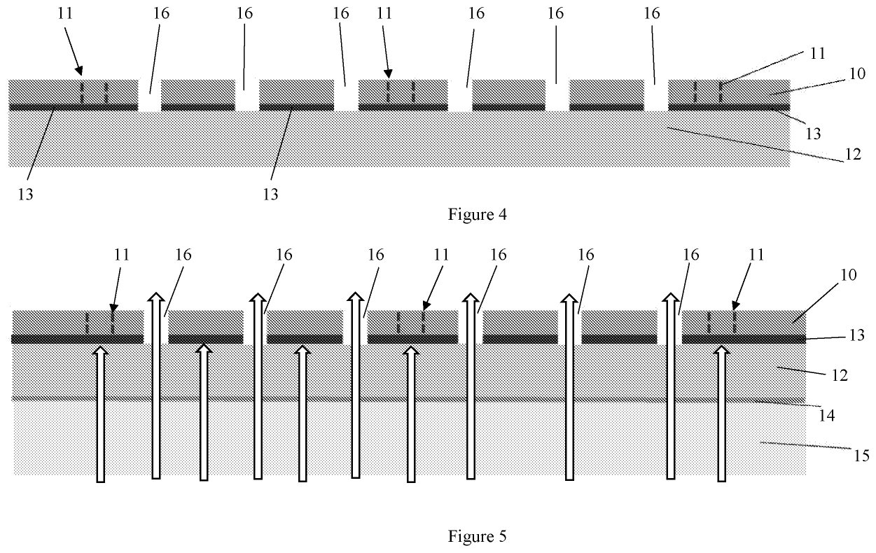

FIG. 5 is a schematic side section view showing the attachment of the trim structure of FIG. 5 to a carrier.

FIG. 6 is a schematic side section view of a trim structure of an embodiment in which an opening is provided in the masking layer for each perforated area.

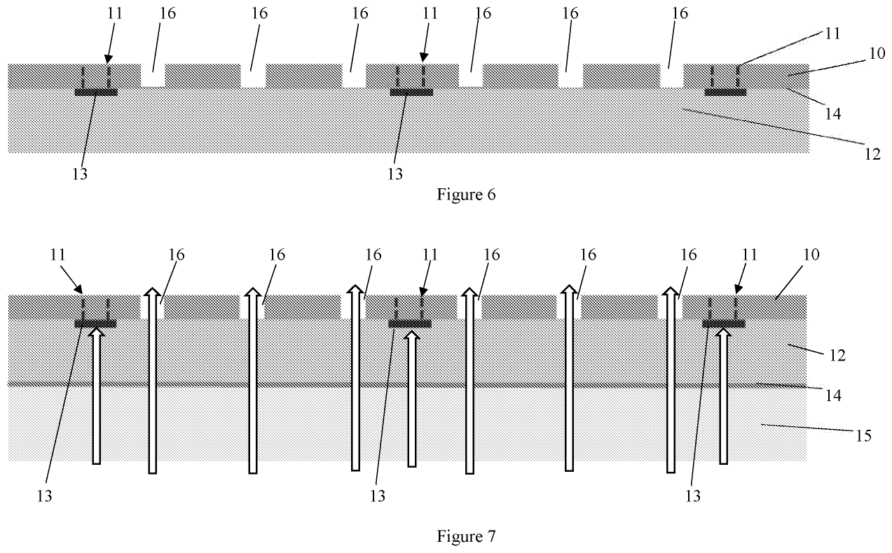

FIG. 7 is a schematic side section view showing the attachment of the trim structure of FIG. 6 to a carrier.

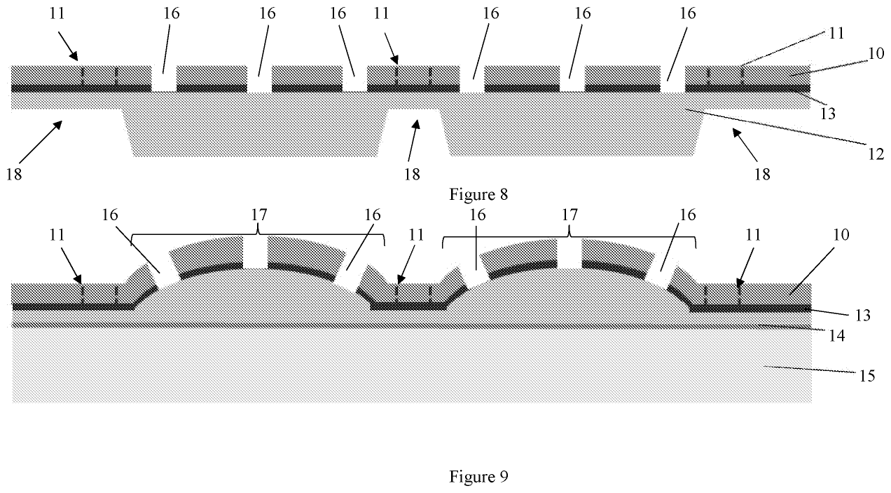

FIG. 8 is a schematic side section view of a quilted effect trim structure of an embodiment in which an opening is provided in the masking layer for each perforation.

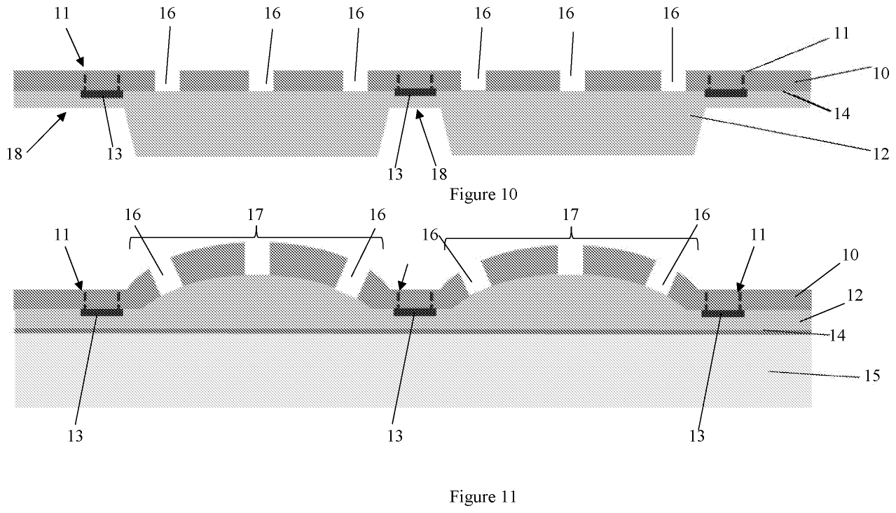

FIG. 9 is a schematic side section view showing the attachment of the trim structure of FIG. 8 to a carrier.

FIG. 10 is a schematic side section view of a quilted effect trim structure of an embodiment in which an opening is provided in the masking layer for each perforated area.

FIG. 11 is a schematic side section view showing the attachment of the trim structure of FIG. 10 to a carrier.

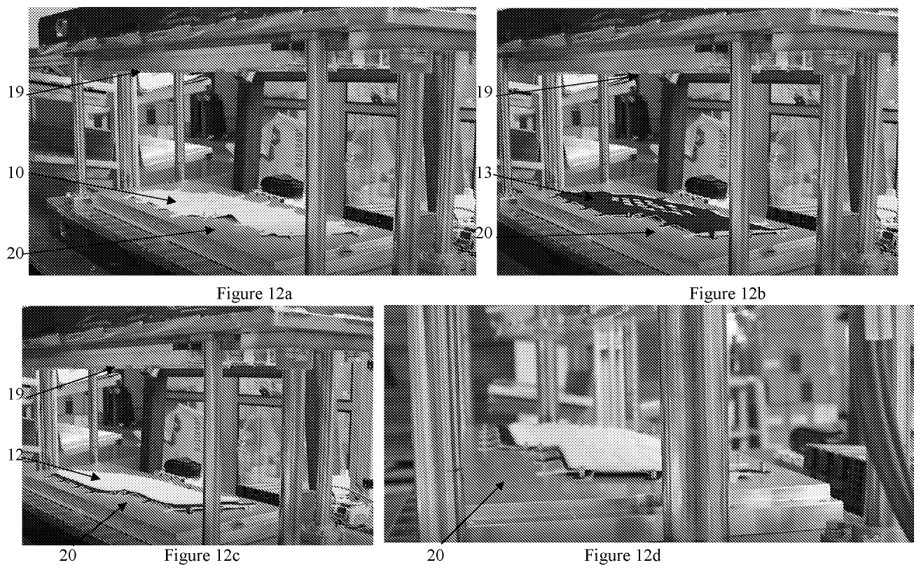

FIG. 12a is an axonometric view of an outer layer in position in a heated press of an embodiment.

FIG. 12b is an axonometric view of a masking layer in position on the outer layer illustrated in FIG. 12a.

FIG. 12c is an axonometric view of a spacer layer on the masking layer illustrated in FIG. 12b.

FIG. 12d is an axonometric view of the layers illustrated in FIG. 12c after pressing.

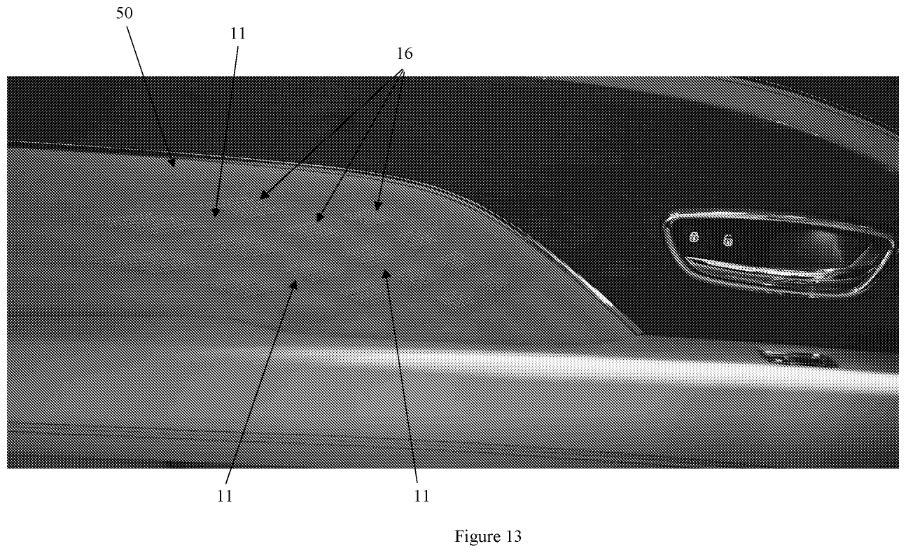

FIG. 13 is a view of a vehicle door with the trim structure assembly of an embodiment in place and illuminated.

According to a preferred embodiment, a layered trim structure 50 to give a quilted and stitched appearance similar to that illustrated in FIG. 1 is provided.

In the prior art trim structure shown in FIG. 1, an outer perforated layer 10 of leather or similar is provided over a deformable substrate (not shown, on underside). Stitching 11 is then used to attach the outer layer and substrate together and the stitching 11 draws the deformable substrate closer to the outer layer 10 to create a quilted effect as shown in FIG. 1.

As illustrated schematically in FIGS. 5 to 11 and in use in FIGS. 12a to 12d, the layered trim structure 50 of the preferred embodiment of the present invention comprises an outer layer 10 comprising a stitched pattern 11 and a plurality of areas of perforations to allow transmission of light. A resiliently compressible spacer layer 12 also configured to allow transmission of light is positioned with at least partially opaque masking layer 13 provided between the outer layer 10 and spacer layer 12. The masking layer 13 is provided with a number of openings corresponding in position to the areas of perforations in the outer layer 10. The openings in the masking layer are illustrated in FIG. 12b in particular.

Preferably, the at least partially opaque masking layer will effectively prevent light from passing except where an opening is formed through the at least partially opaque masking layer. In particular, the at least partially opaque masking layer may include at least one masking portion corresponding to at least the stitched pattern of the outer layer.

This allows passage of light through the spacer layer 12 and through the at least one area of perforations 16 so as to be visible, but prevents light which passes through the spacer layer 12 from passing through the opaque masked portions provided by the masking layer 13 particularly the stitching 11 in the outer layer 10. This allows the layered trim structure to include a stitching pattern on the outer layer 10 but only allows light to pass where the opaque masking layer 13 has an opening, which is in turn aligned with the at least one area of perforations. As shown in FIGS. 5 and 7 in particular, light can shine through the perforations 16, but not elsewhere.

The schematic illustrations shown in FIGS. 4 to 11 are divided into FIGS. 4 to 7 which shown a flat trim structure without a quilted effect and FIGS. 8 to 11 which shown a trim structure according with a 3D, quilted effect.

As shown in FIG. 1, more than one perforation may be provided in at least one perforated area 16.

To achieve a simulation of this effect in the preferred embodiment, each perforation 16 in the outer layer 10 may be aligned with a respective opening in the masking layer 13 as shown in FIGS. 4, 5, 8 and 9.

Alternatively, as shown in FIGS. 6, 7, 10 and 11, an opening in the masking layer may be larger and may be aligned with an area of perforations rather than individual perforations 16. This may make alignment simpler given the larger areas involved and light bleed from one perforation 16 through one or more adjacent perforations is less of a problem.

As shown in FIG. 12a, the outer layer 10 will preferably be cut to a required shape for the trim structure. The cutting to shape and the perforation may be achieved in the same step or in different steps. A die cutting press may be used.

The outer layer 10 of the illustrated embodiment is provided with one or more extensions or tabs extending outwardly from an outer edge thereof as clearly shown in FIG. 12a. Each of the one or more extensions or tabs is provided with an opening or aperture therethrough. The one or more extensions or tabs with an opening or aperture are used to locate the outer layer relative to a lower plate of a press as shown in FIG. 12a. The outer layer 10 is positioned with the ‘A’ surface down and the ‘B’ surface upwardmost. The masking layer 13 is located directly onto the ‘B’ surface of the outer layer, in the press with an adhesive between the layers.

As shown, the perforations are provided in one or more clusters, areas or arrays. Where provided in one or more clusters, areas or arrays, a boundary portion, without perforations is provided, preferably around each cluster, area or array.

Stitching provided in the outer layer 10 may be embroidered into the outer layer 10. In one form, a CNC embroidery machine could be used.

The stitching is preferably into the outer layer only. This contrasts with prior art trim structure in FIG. 1 in which stitching is applied through the outer layer and substrate (spacer layer) to create the quilted effect.

As shown in FIGS. 12b and 12c, the at least partially opaque masking layer 13 is provided between the outer layer 10 and spacer layer 12. As shown in FIG. 12b, the masking layer 13 has a number of openings corresponding in position to the areas of perforations in the outer layer 10.

The masking layer 13 is preferably cut into shape to correspond with the configuration of stitching and areas of perforations in the outer layer 10. The masking layer may be cut to shape using a die cut press.

The same machine may be used to form the perforations in the outer layer 10 and the openings in the masking layer 13.

In the illustrated embodiment, as discussed above, an opening is formed into the masking layer 13 which is sufficiently large to correspond to each area of perforations provided in one or more clusters, areas or arrays with a boundary portion, without perforations, provided around each cluster, area or array in the outer layer. The stitching 11 is provided into the outer layer 10 in the boundary portions.

A masking portion is provided in the masking layer corresponding to the boundary portions. In this configuration, the masking layer 13 will preferably therefore be provided as a layer with a series of openings and a series of connecting, masking portions corresponding to the boundary portions in the outer layer 10, through which the stitching 11 is provided.

As shown in FIG. 12b, the masking layer will preferably have continuous cover on the outer layer 10, except in locations corresponding to the perforations 16.

The masking layer 13 is preferably cut to shape to correspond to the outer layer 10 with one or more extensions or tabs extending outwardly from an outer edge thereof as shown in FIG. 12b. Each of the extensions or tabs are provided with an opening or aperture therethrough. The one or more extensions or tabs with an opening or aperture are used to locate the masking layer 13 on the press, relative to the outer layer 10. Use of the extensions or tabs on the masking layer 13 may assist with alignment of the masking layer 13 correctly with the outer layer 10.

The masking layer 13 will preferably be attached directly to the outer layer 10. The masking layer 13 shown is directly attached to the ‘B’ surface of the outer layer 10 using a heat activated adhesive provided to the outer layer 10, and/or the masking layer 13.

The resiliently compressible spacer layer 12 may be made of a material which in use, diffuses the light as it passes through it. In this embodiment, the spacer layer 12 is operable in use to scatter light from the light source so that it is incident over a broad area of the inner surface of outer cover 10.

The spacer layer 12 may be cut to shape to correspond to the shape required for the trim structure.

The spacer layer may be a fabric or a foam. The outer surface of the spacer layer 12 may be bonded to the inner surface of the at least partially opaque masking layer 13. Whilst any method may be used, a heat activated adhesive may be particularly preferred. The adhesive may be provided to the masking layer 13, and/or the spacer layer 12.

As shown in FIGS. 8 to 11, the spacer layer may be deformed to decreased thickness in areas 18 corresponding to the stitching pattern. The deformed, decreased thickness spacer layer 12 may be formed by compression of the spacer layer 12 corresponding to the stitching pattern. Preferably, any deformation of the spacer layer corresponding to the stitching pattern is permanent.

This deformation can be achieved in a number of ways for example utilising a press. A press may be used at a suitable temperature and/or pressure to compress the spacer layer. A heated press may be used at a suitable temperature and/or pressure to compress the spacer layer. A hand operated roller may be used at a temperature and/or pressure to compress the spacer layer.

As shown in FIGS. 12a to 12d, the press may have an upper (heated) tool 19 with a raised pattern which, in this case, corresponds to the configuration of the outer layer 10. Preferably, the raised pattern corresponds to the configuration of the stitching pattern on the outer layer 10. As shown, the bottom tool 20 of the press may be a planar plate. One or more upstands may be provided relative to the bottom tool in the press and over which the openings in the one or more extensions or tabs on the outer layer 10 and the masking layer 13 are located to align the outer layer 10 and masking layer 13.

In the embodiment shown in FIGS. 12a to 12d, once the outer layer 10, masking layer 13 and spacer layer 12 are positioned in the press, the press is closed in an embossing step, causing the three layers to become adhered together and the spacer layer 12 to be plastically deformed by the raised regions of the top tool in the press. Accordingly, the spacer layer becomes compressed along the lines of stitching as if the spacer layer were quilted (attached to the outer layer by the stitching 11) but without stitching 11 passing through the spacer layer 12 (or masking layer 13). At this stage the A surface of the outer layer 10 may still appear flat and the texture will be on the back (B-surface) of the now-connected three-layer trim structure as shown in FIG. 12d.

In this embodiment, the deformation of the spacer layer 12 is achieved at the same time or as a consequence of attaching the respective layers together.

The embossing step may take place at a temperature between 0° and 300°.

The embossing step may last for between 10 to 120 seconds.

The embossing step may take place at a pressure between 0 Bar and 10 Bar.

As shown in FIGS. 5, 7, 9 and 11, the trim structure assembly may then be attached/adhered to an illuminated/illuminatable substrate 15. Although any method could be used, a spray adhesive 14 may be preferred.

In FIGS. 9 and 11, the trim structure assembly is attached to an illuminated/illuminatable substrate 15. In this embodiment, a cover layer is placed over the A surface of the trim structure assembly and the illuminated/illuminatable substrate 15 located adjacent to the inner surface of the spacer layer 12 (with an adhesive 14 between). The trim structure assembly can then be pressed onto the illuminated/illuminatable substrate 15, for example by hand, with pressure applied particularly along the stitch line/pattern so that adhesive 14 contact is made. A vacuum is then applied so that the reduced atmosphere forces the trim structure assembly into close contact with the illuminated/illuminatable substrate 15 to hold the trim structure assembly in position on the illuminated/illuminatable substrate 15 whilst the adhesive cures. Heat is also used to cure the adhesive more quickly or effectively. This holds the inner surface of the spacer layer 12 (which is deformed 18) in contact with the illuminated/illuminatable substrate 18 with the effect that the “quilted” texture becomes apparent on the A surface. The already deformed parts of the trim structure are then ‘lower’ on the A surface and the remainder will be raised on the A surface due to the thickness of the undeformed spacer layer, to create the quilted effect.

The illuminated/illuminatable substrate may be or include a light source comprising at least one light emitting member or a light emitting film configured in use to emit light into the spacer layer. The light emitting film may be laminated to an inner surface of the spacer layer and/or may be an OLED.

When illuminated, the light is directed into and through the spacer layer 12 and through the perforations 16 in the outer layer 10 whilst not passing through the masking layer 13.

The method of manufacturing a layered trim structure is also represented in flowchart form in FIG. 2. The method comprises the steps of:
1 An outer layer of the trim structure is cut to shape.
2. The outer layer, usually hide is skived (that is cut to a uniform thickness, preferably between 0.6 mm and 1.2 mm). Other materials could be used. Skiving may not be necessary.
3. The outer layer is perforated and cut with tabs around its outside edge each with apertures (laser cut). These tabs are used to locate the outer layer (A surface down, B surface up) during CNC embroidery (Step 4) and on a laminating/embossing press Step 7).
4. The perforated outer layer is then stitched as desired using a CNC embroidery machine. This is a departure from the conventional where stitching is applied through the leather and substrate to create a quilted effect.
5. An opaque masking layer is cut using a press. The particular material used is a material conventionally used for seam sealing on waterproof clothing. This is die cut as per the perforated outer layer. The material is coated on one side with a heat activated adhesive and is cut to have locating tabs as per the perforated outer layer and placed adhesive face down over the outer layer on the press. The opaque material contains openings corresponding to the areas of perforations in the outer layer.
6. A spacer layer is then laid over the opaque masking layer. The spacer layer is plastically deformable and also a good transmitter of light. The spacer layer is also coated with a heat activated adhesive and is placed adhesive side down over the opaque masking layer.
7. In this embodiment, laminating and embossing are achieved at the same time in a laminating/embossing press. The press has an upper (heated) tool with a raised pattern which, in this case, corresponds to the desired diamond pattern stitching on the leather as shown in FIG. 1. The press is closed causing the three layers to become adhered together and the spacer layer to be plastically deformed by the raised regions of the top tool in the press, the bottom tool being a flat plate. So, the spacer layer becomes compressed along the lines of stitching as if it were quilted, but without stitching passing through the spacer layer (or masking layer). In practice, though, at this stage the A surface will still appear flat and all the texture will be on the back (B-surface).

This step could be achieved in a number of ways for example utilising a welding machine or a hand operated roller.
8. The completed assembly is then adhered to the illuminated/illuminatable substrate using a spray adhesive in a vacuum process (similar to vacuum forming). A cover layer is placed over the A surface. The trim structure assembly is then pressed onto the illuminated/illuminatable substrate 15, by hand, with pressure applied particularly along the stitch line/pattern so that adhesive 14 contact is made. A vacuum is then applied to hold the underside of the trim structure assembly into close contact with the illuminated substrate whilst the adhesive cures. Heat is used to assist with curing the adhesive. This forces the spacer layer into contact with the substrate with the effect that the “quilted” texture becomes apparent on the A surface because the deformed parts of the spacer layer (which correspond to the stitching on the A surface) are lower on the A surface of the assembly than the undeformed parts, which gives the appearance of a “quilted” texture.

The process portions a, b and c correspond to the configurations illustrated in FIG. 3

FIG. 13 shows an illuminated trim structure 50 of an embodiment installed into the door of a vehicle. FIG. 13 shows the 3D quilted effect on the trim structure 50 and the light passing through the perforations 16 in the perforated areas, whilst no light is passing through the stitching pattern 16.

The one or more embodiments are described above by way of example only. Many variations are possible without departing from the scope of protection afforded by the appended claims.

1. A layered trim structure comprising an outer layer comprising a stitched pattern and at least one area configured to allow transmission of light, a resiliently compressible spacer layer configured to allow transmission of light and an at least partially opaque masking layer provided between the outer layer and spacer layer, the masking layer configured with at least one opening corresponding in position to the at least one area configured to allow transmission of light.

2. (canceled)

3. A layered trim structure as claimed in claim 1 wherein the at least one area configured to allow transmission of light includes at least one perforation through an opaque outer layer.

4. (canceled)

5. A layered trim structure as claimed in claim 4 wherein each perforation is aligned with a respective opening in the masking layer.

6. (canceled)

7. A layered trim structure as claimed in claim 1 wherein the outer layer is provided with one or more extensions or tabs extending outwardly from an outer edge thereof.

8. A layered trim structure as claimed in claim 7 wherein each of the one or more extensions or tabs is provided with an opening or aperture therethrough.

9. A layered trim structure as claimed in claim 1 wherein the stitching pattern is stitched into the outer layer.

10. A layered trim structure as claimed in claim 1 wherein the masking layer is shaped to correspond with the configuration of the stitching pattern and at least one area configured to allow transmission of light into the outer layer.

11. A layered trim structure as claimed in claim 1 wherein the masking layer has at least one opening corresponding in position to the at least one area configured to allow transmission of light.

12. A layered trim structure as claimed in claim 11 wherein the at least one opening in the masking layer is sufficiently large to correspond to at least one area configured to allow transmission of light including at least one area of perforations provided in one or more clusters, areas or arrays.

13. A layered trim structure as claimed in claim 12 wherein at least one masking portion is provided in the masking layer corresponding to the stitching pattern in the outer layer.

14. (canceled)

15. (canceled)

16. (canceled)

17. (canceled)

18. A layered trim structure as claimed in claim 1 wherein the spacer layer is embossed to deform the spacer layer to decreased thickness in at least one area corresponding to the stitching pattern on the outer layer, before assembly.

19. An illuminated vehicle trim comprising a layered trim structure as claimed in claim 1 and a light source operable in use to direct light through the spacer layer to the outer cover to be visible through the at least one area configured to allow transmission of light.

20. A method of manufacturing a layered trim structure, the method comprising the steps of providing a stitching pattern and at least one area configured to allow transmission of light in an outer layer, positioning an at least partially opaque masking layer comprising at least one opening relative to the outer layer such that the at least one opening in the masking layer corresponds in position to the at least one area configured to allow transmission of light in the outer layer, and placing a resiliently compressible spacer layer configured to allow transmission of light onto at least partially opaque masking layer to sandwich the at least partially opaque masking layer to the outer layer.

21. A method of manufacturing a layered trim structure as claimed in claim 20 further including a step of deforming the spacer layer to decreased thickness corresponding to the stitching pattern.

22. A method of manufacturing a layered trim structure as claimed in claim 21 wherein the deformed, decreased thickness spacer layer is formed by compression of the spacer layer corresponding to the stitching pattern.

23. A method of manufacturing a layered trim structure as claimed in claim 21 wherein the deformation of the spacer layer is achieved at the same time or as a consequence of attaching the respective layers together.

24. A method of manufacturing a layered trim structure as claimed in claim 20 further including a step of pressing the respective layers together using a heated press having at least one raised part corresponding to the stitching pattern in the outer layer to hold the layered trim structure together and to plastically deform the spacer layer corresponding to the stitching pattern.

25. A method of manufacturing a layered trim structure as claimed in claim 20 further including a step using a vacuum process to hold the trim structure assembly relative to an illuminated/illuminatable substrate to hold an inner surface of the spacer layer into contact with the illuminated/illuminatable substrate with the effect that a quilted texture becomes apparent on an outer surface of the outer layer.

26. A method of manufacturing a layered trim structure, the method comprising the steps of providing a stitching pattern and at least one area configured to allow transmission of light in an outer layer, placing a resiliently compressible spacer layer configured to allow transmission of light onto at least partially opaque masking layer to sandwich the at least partially opaque masking layer to the outer layer and deforming the spacer layer to decreased thickness corresponding to the stitching pattern.

27. A method of manufacturing a layered trim structure as claimed in claim 26 wherein the deformed, decreased thickness spacer layer is formed by compression of the spacer layer corresponding to the stitching pattern.
